(19) United States
(12) Patent Application Publication
(10) Pub. No.: US 2011/0201749 A1
(43) Pub. Date: Aug. 18, 2011

(54) PIGMENT AND POLYMERIC MATERIALS DELUSTRED THEREWITH

(76) Inventors: Jurgen KASTNER, Bochum (DE); Hartmut Wagner, Moers (DE); Bernard Becker, Krefeld (DE)

(21) Appl. No.: 13/096,034

(22) Filed: Apr. 28, 2011

Related U.S. Application Data
(63) Continuation of application No. 12/302,327, filed on Nov. 25, 2008, now abandoned.

(30) Foreign Application Priority Data
Jun. 9, 2006 (DE) 10 2006 027 249.8

(51) Int. Cl. C08K 3/22

(52) U.S. Cl. 524/556; 106/441; 106/438

(57) ABSTRACT

The invention provides a pigment, the production and use thereof, furthermore a polymeric material delustred with pigments, processes for producing this polymeric material, and the use thereof.

The invention provides a pigment, the production and use thereof, furthermore a polymeric material delustred with pigments, processes for producing this polymeric material, and the use thereof.

Delustred synthetic fibres are polymeric materials that, for the purpose of achieving a desired delustring effect, contain between 0.03 wt. % and 3 wt. % of an inorganic solid substance, preferably TiO₂ (titanium dioxide). One reason is that polymer melts are more or less transparent, because the homogeneous structure of the synthetic polymers offers light no opportunity for refraction or diffuse reflection. It is known that the addition of TiO₂ results in a diminution of the greasy lustre or transparency of the synthetic fibres, and also in a surface structure that enables an improvement of the running properties of the synthetic fibres in the further processing procedure.

High TiO₂ contents (1.5 wt. % to 3 wt. % TiO₂) in synthetic fibres result in a particularly pronounced delustring effect which can be perceived both visually and haptically (textile feel). This fashioning of synthetic fibres is often desirable, in order to impart a strongly cotton-like appearance to the synthetic fibres. In addition, textile fabrics produced from full-dull fibres fashioned in such a manner exhibit a particularly high impermeability to UV radiation.

Besides their influence on lustre and transparency of synthetic fibres, TiO₂ pigments also influence other production properties and product properties of synthetic fibres in many and various ways. The demands made of the pigments vary with the various types of polymer, the various processes and the various qualities of fibre. The surface properties and pigment properties can be changed by measures such as the incorporation of foreign ions into the TiO₂ lattice, applying an inorganic and/or organic aftertreatment. By virtue of the correct combination of measures, it is possible for a special pigment to be optimised for each polymer. In particular, the dispersibility in application media—such as, for example, ethanediol, water or even polymer melts—and the subsequent distribution of pigment in the fibre can be positively influenced in this manner.

Besides the physical and chemical properties of the synthetic fibres, the optical properties also play a significant role in the quality assessment of the synthetic fibres. The properties constituted by opacity and colour sensation with respect to the colour white should be named here in particular. Most manufacturers of synthetic fibres nowadays prefer a bluish white by way of colour tone for their products. This colour tone of the fibres is influenced by the colorimetric properties of the pigment, by the distribution of the pigment in the fibre, and by the chemical interactions of the pigment surfaces with the surrounding polymer under the respective conditions for producing the appropriate synthetic fibre (for example, temperature and pressure).

The bluish white by way of colour tone that is preferred by the majority of fibre manufacturers is accomplished only to a limited or inadequate extent by today's state of the art. For instance, despite the use of colorimetrically suitable TiO₂ pigments (with bluish white) during application in the course of production and processing of the polymers, undesirable reactions take place which shift the colour tone of the synthetic fibre into the yellowish region.

An object of the present invention was to overcome the disadvantages of the prior art. In particular, an object of the present invention was to make available suitable TiO₂ pigments that, in the course of their use in the production and processing of polymers, trigger no undesirable reactions or only few undesirable reactions, that the undesirable reactions, brought about ordinarily by virtue of the high TiO₂ contents necessary for the delustring, that cause the undesirable shifts of colour tone in the course of production of the polymeric materials, an object of the present invention was to make available TiO₂ pigments that, in the course of production and processing of polymers, generate the desired bluish colour tone and/or preferably a high resistance to light.

A further object of the invention was to make available polymeric materials, delustred with pigments, that do not exhibit, or exhibit to a diminished degree, the undesirable shifts of colour tone brought about ordinarily in the course of production of the polymeric materials by virtue of the TiO₂ contents necessary for the delustring, polymeric materials, delustred with pigments, that are characterised by the desired bluish colour tone and preferably exhibit a high resistance to light.

In accordance with the invention, the objects with regard to the suitable TiO₂ pigments are surprisingly achieved by means of TiO₂ pigments having the features of the main claim. Preferred configurations are characterised in the subclaims that are dependent on the main claim.

With regard to the polymeric materials delustred with pigments, in accordance with the invention the objects are surprisingly achieved by means of polymeric materials, delustred with pigments, having the features of the associated independent claim, claim 22. Preferred configurations are characterised in the subclaims that are dependent on the associated independent claim.

Surprisingly, it has been found that for the purpose of achieving the characteristic properties with respect to bluish tinge of the polymeric material delustred with pigments not only do the colorimetric properties of the pigments have to be adjusted but countermeasures have to be taken simultaneously in order to avoid a shift of colour tone during polymer production.

In the case of a pure-white substance, practically the entire incident radiation is directly or diffusely reflected in a proportion amounting to 100%—that is to say, it is subject to reflectance. But this ideal state (ideal white with reflectance factor equal to 100%) cannot be attained in practice, because the white that is attainable has an absorption—albeit very low—over the entire spectrum. In the case of TiO₂ the reflectance is also influenced by the position of the absorption edge. This absorption edge lies in the UV region but already begins in the visible region. TiO₂ rutiles are more yellowish than TiO₂ anatase pigments, since they absorb more strongly in the ‘blue’ wavelength region and, as a result, their reflected light contains a higher proportion of yellow—that is to say, the absorption edge of anatase is shifted, in comparison with that of rutile, into the shorter-wave region. In addition, white pigments also display selective absorptions in the short-wave visible wavelength region, resulting in a more or less slight colour cast (yellow cast). These selective absorptions may have their cause in contaminations of the white pigments by foreign ions such as, for example, iron, chromium, copper or vanadium ions. For the purpose of adjusting the optical properties of the pigments that are desired in accordance with the invention, TiO₂ in the anatase modification is therefore preferably employed. This TiO₂ is particularly low in foreign ions which would otherwise result in the selective absorptions in the short-wave region of the visible spectrum that have been described.

Moreover, by reason of higher reflectance in the short-wave visible region, in particular the proportion of ultrafine particles in the TiO₂ results in an intensified blue cast. The higher this proportion becomes, the higher also the measured extinction (filter Hg 492 nm, 20 mm cell) of an aqueous TiO₂ suspension (25 mg/l). The TiO₂ pigments that can be employed in accordance with the invention are therefore characterised by a special particle-size distribution for the purpose of adjusting the colorimetric properties of the pigment, expressed by the extinction value. For the purpose of adjusting the suitable colorimetric properties of the pigment, in accordance with the invention an extinction is adjusted within the range from 0.9 to 1.2, preferably within the range from 0.95 to 1.1, particularly preferably within the range from 1.0 to 1.05. A pigment that has been prepared in accordance with the invention in such a way surprisingly does not have a negative influence on other powder properties—for example, opacity and scattering power. In accordance with the invention, the suitable extinction of the TiO₂ may be obtained, for example, by means of optimised crystal-growth processes (influenced and adjusted by the process steps constituted by hydrolysis, incandescent-salt treatment and/or calcination), by means of grinding (dry grinding or wet grinding) and/or by means of size grading (for example, screening or sifting).

Surprisingly, it has been found that the suitability, desired in accordance with the invention, of the TiO₂ pigment according to the invention for the purpose of achieving the desired bluish tinge in the delustred polymeric material can be further improved through the addition of antimony ions. Preferred in accordance with the invention is a content of antimony ions from 0.05 wt. % to 1 wt. %, preferably from 0.1 wt. % to 0.5 wt. %, particularly preferably from 0.25 wt. % to 0.4 wt. %. In accordance with the invention it is particularly preferred if at least 50%, preferably more than 70%, particularly preferably more than 90%, of the antimony ions are present in the pigment in the pentavalent oxidation state.

With the aid of this TiO₂ pigment which has been prepared in accordance with the invention it is possible for the desired bluish tinge to be achieved in the delustred polymeric material, in which connection it is ensured, by virtue of the content of antimony ions, that the optical powder data (colour cast) of the pigment are also preserved in the finished polymeric material and are not changed by means of colour-impairing reactions in polymer production; the antimony ions serve virtually by way of ‘conservation’. The addition of the antimony may be effected in the form of an antimony salt or in the form of an oxidic antimony compound in all process stages of TiO₂ production.

With a view to improving the workability into the various polymer systems, and/or with a view to increasing the resistance of the TiO₂-containing polymeric materials to light, the TiO₂ pigments according to the invention may further have been modified by means of an inorganic and/or organic surface treatment. For the purpose of inorganic surface treatment of the TiO₂, oxides and/or hydroxides of aluminium (Al), of silicon (Si), of zirconium (Zr), of manganese (Mn) but also of titanium (Ti) find application in accordance with the invention. In accordance with the invention, inorganic aftertreatments do not necessarily have to be of oxidic nature only but may also contain other anions. For example, aluminium, titanium and manganese form sparingly soluble phosphates which likewise attach themselves to the pigment surface. The principle underlying the surface treatment according to the invention is that an aqueous dispersion of a ground TiO₂ material is presented, and the compound to be precipitated is added in initially dissolved form. By purposeful alteration of the pH value (for example, by addition of caustic-soda solution, sulfuric acid or phosphoric acid), the desired inorganic substance is precipitated on the TiO₂ base material. In this way, in accordance with the invention it is possible for the TiO₂ particles to be coated with a layer or with several layers of inorganic substances. In accordance with the invention this surface treatment may be effected in succession, but it may also be effected simultaneously. With a view to achieving the resistance to light that is desired in accordance with the invention, the inorganic aftertreatment preferably includes a combination of compounds of aluminium, of silicon and of manganese, particularly preferably 0.2% to 1.0% Al, 0% to 1.0% Si and 0.05% to 0.8% Mn. The aftertreatment quantities are ordinarily specified as percentage by weight of the cation, relative to the TiO₂ base material employed, for example 0.5% aluminium. It is particularly preferred in accordance with the invention if the manganese is present in a proportion amounting to more than 5% in the +2 oxidation state, particularly preferably in a proportion amounting to more than 10% in the +2 oxidation state.

In order to be able to work the inorganically surface-treated TiO₂ pigments still better into the various application media (for example, water, ethanediol, propanediol, polyamide melts or polyester melts), in accordance with the invention the TiO₂ pigments may additionally be modified with at least one organic substance (organic surface treatment). The organic surface treatment preferably includes one or more of the following substances: polyglycols (for example, polyethylene glycols or polypropylene glycols or even copolymers formed therefrom), carboxylic acids, alkali salts of carboxylic acids, polyhydric alcohols (for example, trimethylolpropane, trimethylolethane, pentaerythritol neopentyl glycol), silanes, siloxanes and siloxane derivatives, silicone oils, alkali salts of polyphosphates, amino alcohols, salts of poly(meth)acrylic acid or poly(meth)acrylate copolymers (for example, sodium polyacrylates, potassium polyacrylates or ammonium polyacrylates). The added quantity of the organic surface-treatment agents (total quantity) is preferably between 0.01 wt. % and 8 wt. %, particularly preferably between 0.05 wt. % and 4 wt. %, and quite particularly preferably between 0.1 wt% and 1.5 wt. %.

In accordance with the invention, the addition of the organic surface-treatment agents may be effected in all process stages after application of the inorganic surface treatment or, in the case of TiO₂ pigments that have not been surface-treated inorganically, in all process stages after the calcination.

The polymeric material preferably contains polyesters (such as polyethylene terephthalate (PET), polytrimethylene terephthalate (PTT), polyactide (PLA)), polyamides (such as PA-6 or PA-66), polyolefins (such as polyethylene (PE) or polypropylene (PP)), polyacrylonitriles (PAN), viscose (CV) or cellulose acetate (CA).

The form of the polymeric material according to the invention is not restricted to a particular type. The polymeric material according to the invention is preferably present in the form of synthetic fibres (such as filaments, staple fibres or flock fibres). In accordance with the invention, the polymeric material may also be present in the form of films, sheets or mouldings.

In accordance with the invention, the TiO₂ content in the polymeric material preferably lies within the range from 0.02 wt. % to 10 wt. %. In accordance with the invention, in the case of the field of application constituted by synthetic fibres the TiO₂ content preferably amounts to 0.1 wt. % to 3 wt. %, particularly preferably 1.5 wt. % to 2.7 wt. %, and quite particularly preferably 0.15 wt. % to 0.4 wt. %. In accordance with the invention, in the case of the field of application constituted by polymeric film the TiO₂ content lies particularly preferably within the range from 0.1 wt. % to 8 wt. % and amounts, quite particularly preferably, to 0.4 wt. % to 5 wt. %.

The polymeric materials according to the invention can be produced by the TiO₂ pigment according to the invention being employed instead of the additive TiO₂ customary hitherto. In accordance with the invention, the addition of this TiO₂ pigment may be effected in known manner before, during and/or after the polymerisation reaction. The TiO₂ pigment according to the invention is preferably added to the polymer production process in the form of a completely dispersed suspension in water (for PA) or in ethanediol (for PET). The addition to the polyester stream in the form of a so-called master batch or in the form of a preparation that can be readily distributed in the melt is expediently effected when the polymer process does not permit an addition during the polymerisation (for example, in the case of PE or PP) or is purposefully desired, such as, for example, in the case of the melt-conditioning process or direct-delustring process (for example, in the case of PET or PA-6).

The polymeric material according to the invention finds application, for example, in the production of textile fabrics, such as, for example, for clothing textiles or home textiles. The polymeric material according to the invention finds further application, for example, in the production of polymeric films and sheets (for example, for packaging or printing applications).

In detail, the invention provides:
a TiO₂ pigment;
a TiO₂ pigment that is present in the anatase modification;
a TiO₂ pigment that is present in the anatase modification and is characterised by a special particle-size distribution for the purpose of adjusting the colorimetric properties of the pigment, expressed by the extinction value, in which connection
   the extinction value lies within the range from 0.9 to 1.2, preferably within the range from 0.95 to 1.1, particularly preferably within the range from 1.0 to 1.05;
a TiO₂ pigment as described above, which furthermore contains antimony ions,
   the content of antimony ions amounting to 0.05 wt. % to 1 wt. %, preferably 0.1 wt. % to 0.5 wt. %, particularly preferably 0.25 wt. % to 0.4 wt. %
   the antimony ions being present in the pentavalent oxidation state in a proportion amounting to at least 50%, preferably more than 70%, particularly preferably more than 90%
a TiO₂ pigment as described above, which has furthermore been subjected to an inorganic surface treatment, wherein
   the TiO₂ particles are coated with a layer or with several layers of inorganic and/or organic substances, wherein
   use is made of compounds of aluminium (Al), of silicon (Si), of zirconium (Zr), of manganese (Mn) or of titanium (Ti) by way of inorganic substances, wherein preferably
   use is made of a combination of compounds of aluminium (Al), of silicon (Si) and of manganese (Mn), preferably
   in quantities from 0.2% to 1.0% Al, 0% to 1.0% Si and 0.06% to 0.8% Mn (specified in percentage by weight of the cation, relative to the TiO₂ base material employed), wherein
   the manganese is preferably present in a proportion amounting to more than 5% in the +2 oxidation state, particularly preferably in a proportion amounting to more than 10% in the +2 oxidation state
   use is made of polyglycols (for example, polyethylene glycols or polypropylene glycols or even copolymers formed therefrom), carboxylic acids, alkali salts of carboxylic acids, polyhydric alcohols (for example, trimethylolpropane, trimethylolethane, pentaerythritol or neopentyl glycol), silanes, siloxanes and siloxane derivatives, silicone oils, alkali salts of polyphosphates, amino alcohols, salts of poly(meth)acrylic acid or poly(meth)acrylate copolymers (for example, sodium polyacrylates, potassium polyacrylates or ammonium polyacrylates) or mixtures thereof by way of organic substances, preferably
   in quantities from 0.01 wt. % to 8 wt. %, particularly preferably from 0.05 wt. % to 4 wt. %, quite particularly preferably from 0.1 wt. % to 1.5 wt. %.
a process for producing the TiO₂ pigment;
the use of the TiO₂ pigment;
the use of the TiO₂ pigment for the purpose of producing polymeric materials;
a polymeric material delustred with pigments;
a polymeric material delustred with pigments, which contains one or more substances selected from the group comprising polyesters, polytrimethylene terephthalate, polyactide, polyamides, polyolefins, polyacrylonitriles, viscose or cellulose acetate;
a polymeric material delustred with pigments, which contains 0.02 wt. % to 10 wt. % of the TiO₂ pigment according to the invention;
a polymeric material delustred with pigments, which in the field of application constituted by synthetic fibre contains 0.02 wt. % to 10 wt. %, preferably 0.1 wt. % to 3 wt. %, particularly preferably 0.15 wt. % to 0.4 wt. % or 1.5 wt. % to 2.7 wt. %, of the TiO₂ pigment according to the invention;
a polymeric material delustred with pigments, which in the field of application constituted by film or sheet contains 0.02 wt. % to 10 wt. %, preferably 0.1 wt. % to 8 wt. %, particularly preferably 0.4 wt. % to 5 wt. %, of the TiO₂ pigment according to the invention;
a process for producing the polymeric material delustred with pigments;
a process for producing the polymeric material delustred with pigments, wherein the addition of the TiO₂ pigment according to the invention may be effected before, during and/or after the polymerisation reaction;
a process for producing the polymeric material delustred with pigments, wherein the addition of the TiO₂ pigment according to the invention may be effected in the form of a master batch;
a process for producing the polymeric material delustred with pigments, wherein the addition of the TiO₂ pigment according to the invention may be effected in the form of a preparation that can be readily distributed in the respective polymer melt;
the use of the polymeric material delustred with pigments for the purpose of producing synthetic fibres;
the use of the polymeric material delustred with pigments for the purpose of producing textile fabrics;
the use of the polymeric material delustred with pigments for the purpose of producing films and/or sheets;
the use of the polymeric material delustred with pigments for the purpose of producing mouldings.

1-32. (canceled)

33. A TiO₂ pigment present in the anatase modification and having an extinction value within the range from 0.9 to 1.2 and comprising antimony ions, wherein the organic substance is a polyglycol,

34. A TiO₂ pigment present in the anatase modification and having an extinction value within the range from 0.9 to 1.2 and comprising antimony ions, wherein the organic substance is a polyglycol.

35. A TiO₂ pigment according claim 34, wherein the extinction value lies within the range from 0.95 to 1.1.

36. A TiO₂ pigment according to claims 35, wherein the content of antimony ions is 0.05 wt % to 1 wt. %

37. A TiO₂ pigment according to claim 35, wherein the antimony ions are present in the pentavalent oxidation state in a proportion amounting to at least 50%.

38. A TiO₂ pigment according to claim 34, wherein it has additionally been subjected to a surface treatment.

39. A TiO₂ pigment according to claims 34, wherein it has been coated with a layer or with several layers of at least one of an inorganic or organic substance.

40. A TiO₂ pigment according to claim 39, wherein the inorganic substance comprises at least one of aluminum, silicon, zirconium, manganese or titanium.

41. A TiO₂ pigment according to claim 39, wherein the inorganic substance comprises a combination of aluminum, silicon and manganese.

42. A TiO₂ pigment according to claim 41, containing 0.2% to 1.0% Al, 0% to 1.0% Si and 0.5% to 0.8% Mn specified in percentage by weight of the cation, relative to the TiO₂.

43. A TiO₂ pigment according to claim 42, wherein the manganese is preferably present in a proportion amounting to more than 5% in the +2 oxidation state.

44. A TiO₂ pigment according to claim 34, coated with at least one layer of an organic substance.

45. A TiO₂ pigment according to claim 44, wherein the organic substance is a polyglycol, a carboxylic acid, an alkali salt of a carboxylic acid, a polyhydric alcohol, a silane, a siloxane, a siloxane derivative, a silicone oil, an alkali salt of a polyphosphate, an amino alcohol, a salt of a poly(meth)acrylic acid or a poly(meth)acrylate copolymer or mixtures thereof

46. A TiO₂ pigment according to claim 44, wherein the organic substances are present in an amount of from 0.01 wt. % to 8 wt. %.
